(19) United States
(12) Patent Application Publication
(10) Pub. No.: US 2013/0102260 A1
(43) Pub. Date: Apr. 25, 2013

(54) APPARATUS AND METHOD FOR DISCOVERING DEVICE IN PORTABLE TERMINAL

(71) Applicant: SAMSUNG ELECTRONICS CO. LTD., Suwon-si (KR)

(72) Inventors: Ju-Ah LEE, Gwangmyeong-si (KR); Jong-Mu CHOI, Gunpo-si (KR)

(73) Assignee: SAMSUNG ELECTRONICS CO. LTD., Suwon-si (KR)

(21) Appl. No.: 13/659,150

(22) Filed: Oct. 24, 2012

(30) Foreign Application Priority Data
Oct. 25, 2011 (KR) 10-2011-0109257

(51) Int. Cl. H04W 48/16

(52) U.S. Cl. 455/73

(57) ABSTRACT

An apparatus and a method for discovering a device in a portable terminal, which can restrict an operation of discovering a device repeated in a communication mode of the portable terminal, are provided. The apparatus includes a memory for storing at least one condition for stopping the discovery of a device, and a control unit for, when the at least one condition for stopping the discovery of a device is satisfied in a device discovering operation for a connection in a communication mode, controlling such that the device discovering operation is stopped.

### PRIORITY

This application claims the benefit under 35 U.S.C. §119(a) of a Korean application filed in the Korean Industrial Property Office on Oct. 25, 2011 and assigned Serial No. 10-2011-0109257, the entire disclosure of which is hereby incorporated by reference.

### BACKGROUND OF THE INVENTION

1. Field of the Invention

The present invention relates to an apparatus and a method for discovering a device in a portable terminal. More particularly, the present invention relates to an apparatus and a method for discovering a device in a portable terminal, which can limit repeated performance of an operation of discovering a device repeated in a communication mode of the portable terminal.

2. Description of the Related Art

Wi-Fi peer-to-peer or Wi-Fi Direct is a technology that allows Wi-Fi terminals to connect to each other directly by utilizing a Wi-Fi interface without any Access Point (AP) serving as an intermediary in an existing infrastructure network. Wi-Fi technologies have mostly aimed at an Internet connection through APs, and have failed to consider a direct communication between Wi-Fi terminals. Such a problem has been compensated by Bluetooth to some degree, but Wi-Fi P2P is expected to supplement or replace Bluetooth.

Wi-Fi has provided a scheme for direct connection such as a so-called “Ad-hoc mode”, but this scheme has been rarely used in practice due to various defects such as weak security, a power consumption problem, and a throughput limitation to 11 Mbps. Wi-Fi P2P supplements this weak security by supporting a WPA2 security mode and a simple connectivity between Wi-Fi terminals using Wi-Fi Simple Configuration (WSC). Wi-Fi P2P also supports 802.11n to significantly improve its throughput compared to that of Ad-hoc. An improved power consumption algorithm has also been added to Wi-Fi P2P.

Due to Wi-Fi Direct being a standard based on IEEE 802.11 of Legacy Wi-Fi, Wi-Fi Direct may be compatible with a Legacy Wi-Fi terminal and may be easily upgraded without any change in its hardware.

A P2P group is a connection between Wi-Fi terminals using Wi-Fi P2P. Assuming a 1:1 connection, one device acts as a Group Owner (GO) and the other device acts as a Group Client (GC). The GO terminal performs a function as a WLAN AP and the GC terminal performs a function as a WLAN station.

A role of each P2P terminal is determined through a protocol dedicated for P2P such as a group owner negotiation of a Wi-Fi P2P connection. Creating a P2P group using the Wi-Fi P2P technology allows an 1:N connection as well as the 1:1 connection, and the number of allowable GCs is determined by a capacity of the GO terminal.

In a Wi-Fi P2P connecting process, devices are discovered through a device discovery process. A provisional discovery is performed with a device which is desired to be connected among the discovered devices. The provisional discovery process is adapted to inform a device to be connected of a connection method. A WSC connection method includes PBC performed through a button input or PIN performed through a pin number input.

Thus, a desired connection method message is transmitted, and a device having received the message informs a counterpart through a popup or other message delivery scheme. The popup contains information such as a device name having requested a provisional discovery, and a user of the device having received a request determines whether to accept a connection and enables WSC.

Mutual roles of the terminals are determined through a GO negotiation process after the provisional discovery process. A device having been determined as a GO acts as an AP. A device having been determined as a GC acts as a Wi-Fi station.

After the GO or GC is determined, the two devices exchange provisioning processes through authentication information and then complete a P2P connection.

In a device discovery process of the Wi-Fi P2P connection process, the device discovering operation is classified into a scanning operation and a finding operation. First, all channels are scanned through the scanning operation and existence of another Wi-Fi P2P device is identified. When the searching operation is completed, the discovering operation is performed. The discovering operation includes a listening operation and a searching operation.

When the scanning operation is completed, a listening operation time is set at random. The listening operation is performed for a set listening operation time, and the listening operation refers to an RX mode state for responding to a request for another Wi-Fi P2P device.

When the set listening operation time elapses, a searching operation of scanning channels 1, 6, and 11 for a predetermined time and informing a user of existence of another Wi-Fi P2P device is performed. When the searching operation is completed, the listening operation time is set at random again and the listening operation is performed. When the listening operation time elapses, the searching operation is performed again.

In the device discovering operation, the listening operation and the searching operation are repeated so that another device can discover itself or discover another device. However, there is no rule for defining when the listening operation and the searching operation have to be repeated, and the repetitions of the listening operation and the searching operation may cause excess consumption of power.

### SUMMARY OF THE INVENTION

Aspects of the present invention are to address at least the above-mentioned problems and/or disadvantages and to provide at least the advantages described below. Accordingly, an aspect of the present invention is to provide an apparatus and a method for discovering a device in a portable terminal, which can restrict an operation of discovering a device repeated in a communication mode of the portable terminal.

In accordance with an aspect of the present invention, an apparatus for discovering a device in a portable terminal is provided. The apparatus includes a memory for storing at least one condition for stopping a device discovering operation for a connection in a communication mode, and a control unit for, when the at least one condition for stopping the device discovering operation is satisfied in the device discovering operation, controlling such that the device discovering operation is stopped.

In accordance with another aspect of the present invention, a method for discovering a device in a portable terminal is provided. The method includes performing a device discovering operation for a connection in a communication mode, and when at least one condition for stopping the device discovering operation is satisfied during the device discovering operation, stopping the device discovering operation.

In accordance with another aspect of the present invention, a method of device discovery in a terminal supporting Wi-Fi Peer-to-Peer (P2P) is provided. The method includes scanning each communication channel to identify whether another Wi-Fi P2P device is present, setting a random listening time, responding to any received request from another Wi-Fi P2P device for the set random listening time, after the set random listening time elapses, scanning predetermined channels and informing the user of the existence of the another Wi-Fi P2P device, and when a predetermined condition occurs during the scanning of each communication channel, the responding to the received request, and/or the scanning of the predetermined channels, terminating the method of device discovery.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 is a block diagram illustrating a portable terminal according to an exemplary embodiment of the present invention; and

FIGS. 2A and 2B are flowcharts illustrating a process of performing a device discovering operation in a Wi-Fi P2P mode of a portable terminal according to an exemplary embodiment of the present invention.

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding, but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but are merely used by the inventor to enable a clear and consistent understanding of the invention. Accordingly, it should be apparent to those skilled in the art that the following description of exemplary embodiments of the present invention is provided for illustration purposes only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Although a Wi-Fi P2P communication mode will be exemplified as a communication mode for connection of a device in a portable terminal in the exemplary embodiments of the present invention described below, exemplary embodiments of the present invention may be applied to all communication modes for performing a device discovering operation for a connection as well as the Wi-Fi P2P communication mode.

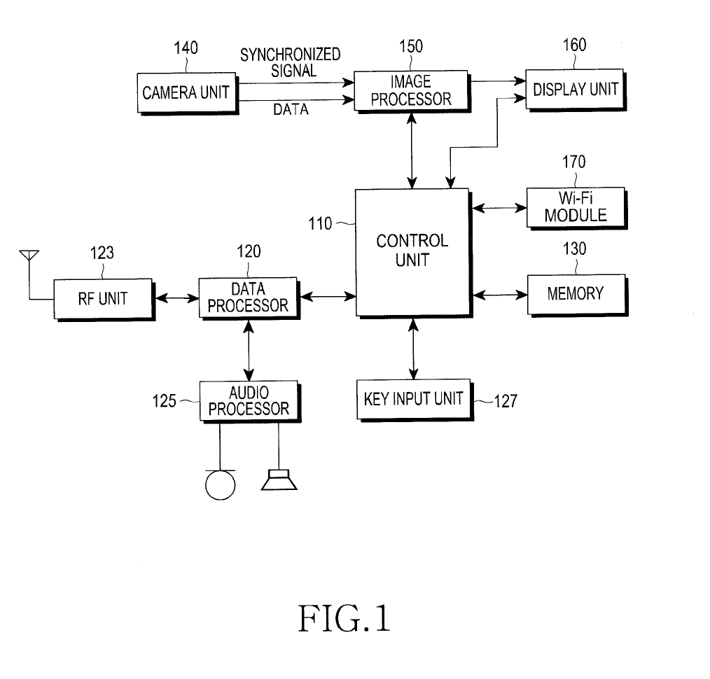

FIG. 1 is a block diagram illustrating a portable terminal according to an exemplary embodiment of the present invention.

Referring to FIG. 1, an RF unit 123 performs a wireless communication function of the portable terminal. The RF unit 123 includes an RF transmitter for up-converting and amplifying a frequency of a transmitted signal, and an RF receiver for low-noise amplifying the received signal and down-converting the frequency. A data processing unit 120 includes a transmitter for encoding and modulating the transmitted signal, and a receiver for demodulating and decoding the received signal. The data processing unit 120 may include a modem and codecs. The codecs include a data codec for processing packet data and an audio codec for processing audio signals. An audio processing unit 125 reproduces a received audio signal output from an audio codec of the data processing unit 120 or transmits a received audio signal generated by a microphone to the audio codec of the data processing unit 120.

A key input unit 127 includes keys for inputting number and letter information, and function keys for setting various functions. The key input unit 127 may be implemented as any manner of key input units, such as buttons, a number pad, or keyboard. Alternatively, if the display unit 160 is implemented as a touch screen, the key input unit 127 may be omitted.

A memory 130 may include a program memory and a data memory. The program memory may store programs for controlling a general operation of the portable terminal and programs for controlling such that a device discovering operation is stopped if at least one condition for stopping the discovery of a device occurs. The data memory performs a function of temporarily storing data generated while the programs are executed.

The at least one condition for stopping the discovery of a device includes a lapse of a predetermined device discovering time, selection of a device for creating a group, and termination of a related application.

The device discovering time may be set by a user or to a default value. The selection of a device for creating a group indicates that a user tries to create a group for the corresponding device among devices discovered and displayed through a device discovering operation. The termination of a related application indicates termination of a Wi-Fi P2P related application which is being executed by the portable terminal.

A time for a device discovering operation is restricted by setting the device discovering time, and the device discovering operation which may be repeated is restricted by setting the device discovering operation which has been performed as a background operation to be stopped if the selection of a device for creating a group or the termination of the related application is satisfied.

A control unit 110 performs a function of controlling overall functions of the portable terminal. If at least one condition for stopping the discovery of a device in a device discovering operation for a connection in a Wi-Fie P2P mode is satisfied, the control unit 110 controls such that the device discovering operation is stopped.

If at least one of a lapse of a predetermined device discovering time, selection of a device for creating a group, and termination of a related application is satisfied while a scanning operation is performed in a device discovering operation of the Wi-Fi P2P mode, the control unit 100 controls such that the device discovering operation is stopped.

If at least one of a lapse of a predetermined device discovering time, selection of a device for creating a group, and termination of a related application is satisfied while a finding operation is performed in the device discovering operation after the scanning operation, the control unit 110 controls such that the device discovering operation is stopped.

If at least one of a lapse of a predetermined device discovering time, selection of a device for creating a group, and termination of a related application is satisfied while a listening operation is performed in the finding operation, the control unit 110 controls such that the device discovering operation is stopped.

If at least one of a lapse of a predetermined device discovering time, selection of a device for creating a group, and termination of a related application is satisfied while a listening operation time elapses in the finding operation and a searching operation is performed in the finding operation, the control unit 110 controls such that the device discovering operation is stopped.

A Wi-Fi module 170 provides a near field communication based on a standard of IEEE 802.11. The user of the portable terminal may form (or create) a Wi-Fi direct group and use a data exchanging function.

A camera unit 140 includes a camera sensor for photographing image data and converting a photographed optical signal to an electrical signal, and a signal processor for converting an analog image signal photographed by the camera sensor to digital data. The camera sensor may be a CCD or CMOS sensor, and the signal processor may be realized by a digital signal processor. The camera sensor and the signal processor may be realized integrally or separately.

The image processing unit 150 performs Image Signal Processing (ISP) for displaying an image signal output from the camera unit 140 on a display unit 160. The ISP includes a function such as gamma correction, interpolation, a spatial change, an image effect, an image scaling, an AWB, an AE, or an AF. The image processing unit 150 processes an image signal output from the camera unit 140 in units of frames, and outputs the frame image data depending on the feature and size of the display unit 160. The image processing unit 150 includes an image codec, and compresses the frame image data displayed on the display unit 160 in a preset manner or restores the compressed frame image data to the original frame image data. The image codec may be a JPEG codec, an MPEG4 codec, and/or a Wavelet codec. The image processing unit 150 is assumed to include an On Screen Display (OSD) function, and may output on-screen display data according to a size of a screen displayed under the control of the control unit 110.

The display unit 160 displays an image signal output from the image processing unit 150 on a screen, and displays user data output from the control unit 110. A Liquid Crystal Display (LCD) may be used as the display unit 160, in which case the display unit 160 may include an LCD controller, a memory for storing image data, and an LCD display element. When the LCD is realized in a touch screen manner, it may be operated as an input unit. In this case, the display unit 160 may display keys such as those of the key input unit 127.

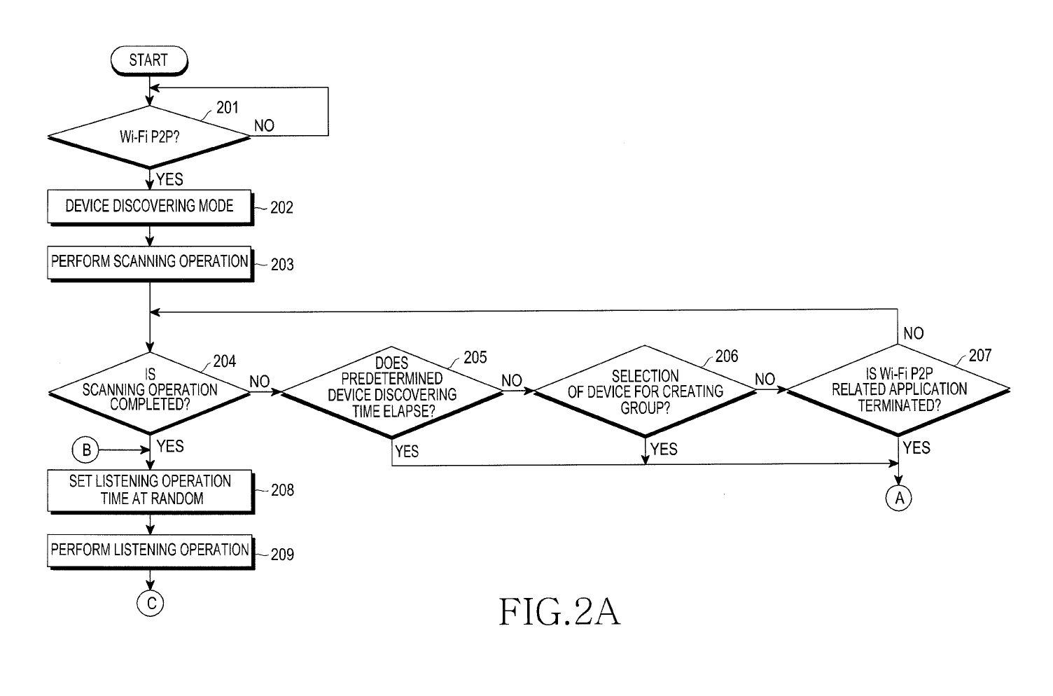

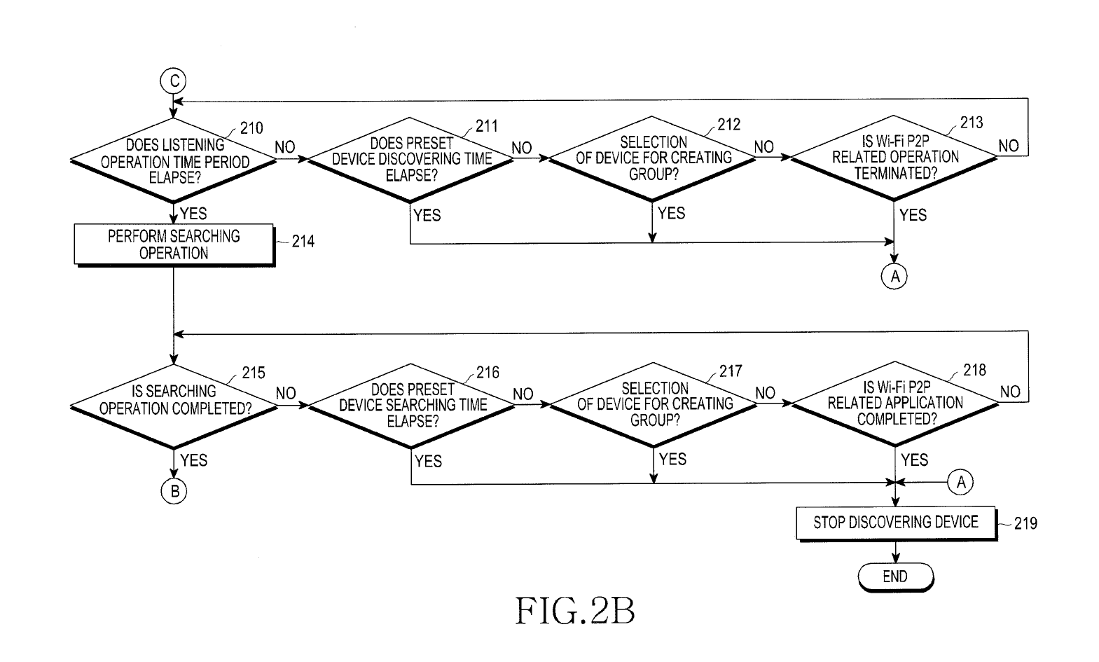

A process of discovering a device in the above-described portable terminal if described below with respect to FIGS. 2A and 2B.

FIGS. 2A and 2B are flowcharts illustrating an operation of discovering a device in a Wi-Fi P2P mode of a portable terminal according to an exemplary embodiment of the present invention.

Referring to FIGS. 2A and 2B, when a Wi-Fi P2P mode is selected in the portable terminal in step 201, the control unit 110 implements the Wi-Fi P2P mode and a device discovering mode in step 202.

In step 203, a scanning operation of scanning all channels and identifying the existence of another Wi-Fi P2P device in the device discovering mode is performed. In step 204, the control unit 110 determines whether the scanning operation is completed. While the scanning operation is performed (i.e., not yet completed), the control unit determines in steps 205-207 whether a predetermined condition has been satisfied.

If a preset device discovering time elapses during the scanning operation in step 205, the control unit 110 stops the device discovering operation in step 219.

If a corresponding device among the discovered devices is selected to create a group before the preset device discovering time elapses during the scanning operation in step 206, the control unit 110 stops the device discovering operation in step 219.

If a Wi-Fi P2P related application is terminated before the preset device discovering time elapses during the scanning operation in step 207, the control unit 110 stops the device discovering operation in step 209.

When the scanning operation is completed in step 204, the control unit 110 sets a listening operation time at random in step 208, and performs a listening operation of responding to a request of another Wi-Fi P2P device for the set listening operation time in step 209. In step 210, the control unit 110 determines whether the listening operation has completed. While the listening operation is being performed (i.e., has not yet completed), the control unit determines in steps 211-213 whether a predetermined condition has been satisfied.

If the preset device discovering time elapses during the listening operation in step 211, the control unit 110 stops the device discovering operation in step 219.

If a corresponding device among the discovered devices is selected to create a group before the preset device discovering time elapses during the listening operation in step 212, the control unit 110 stops the device discovering operation in step 219.

If a Wi-Fi P2P related application is terminated before the preset device discovering time elapses during the listening operation in step 213, the control unit 110 stops the device discovering operation in step 219.

When a listening operation time set at random in step 208 elapses in step 210, the control unit scans channels 1, 6, and 11 for a predetermined time and performs a searching operation in step 214 of informing a user of the existence of another Wi-Fi P2P device. In step 215, the controller determines whether the searching operation has been completed. While the searching operation is being performed (i.e., the searching operation has not yet completed), the controller determines whether a predetermined condition has been satisfied in steps 216-218.

If the preset device discovering time elapses during the searching operation in step 216, the control unit 110 stops the device discovering operation in step 219.

If a corresponding device among the discovered devices is selected to create a group before a preset device discovering time elapses during the searching operation in step 217, the control unit 110 stops the device searching operation in step 219.

If a Wi-Fi P2P related application is terminated before a preset device discovering time elapses during the searching operation in step 218, the control unit 110 stops the device discovering operation in step 219.

When the searching operation is completed in step 215, the control unit 110 returns to step 208.

FIGS. 2A and 2B illustrate an example of stopping the device discovering operation when any one of a lapse of a predetermined device discovering time, selection of a device for creating a group, and termination of a related application, which are the at least one condition for stopping the discovery of a device is performed. However, the device discovering operation may be stopped when at least two conditions are satisfied by combining the conditions for stopping the discovery of a device.

Accordingly, exemplary embodiments of the present invention provide an apparatus and a method for discovering a device in a portable terminal, restricting a device discovering operation which may be repeated and reducing current consumption.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. An apparatus for discovering a device in a portable terminal, the apparatus comprising:
a memory for storing at least one condition for stopping a device discovering operation for a connection in a communication mode; and
a control unit for, when the at least one condition for stopping the device discovering operation is satisfied during the device discovering operation, controlling such that the device discovering operation is stopped.

2. The apparatus as claimed in claim 1, wherein the communication mode corresponds to Wi-Fi Peer-to-Peer or Wi-Fi Direct.

3. The apparatus as claimed in claim 1, wherein the at least one condition for stopping the device discovering operation comprises a lapse of a predetermined device discovering time, selection of a device for creating a group, and termination of a related application.

4. The apparatus as claimed in claim 1, wherein when at least one of the lapse of the predetermined device discovering time, selection of the device for creating the group, and termination of the related application is satisfied during a scanning operation in the device discovering operation, the control unit controls such that the device discovering operation is stopped.

5. The apparatus as claimed in claim 4, wherein when at least one of the lapse of the predetermined device discovering time, selection of the device for creating the group, and termination of the related application is satisfied during a finding operation after completing the scanning operation of the device discovering operation, the control unit controls such that the device discovering operation is stopped.

6. The apparatus as claimed in claim 5, wherein when at least one of the lapse of the predetermined device discovering time, selection of the device for creating the group, and termination of the related application is satisfied during a listening operation in the finding operation, the control unit controls such that the device searching operation is stopped.

7. The apparatus as claimed in claim 6, wherein when at least one of the lapse of the predetermined device discovering time, selection of the device for creating the group, and termination of the related application is satisfied during a searching operation after the lapse of the listening operation of the finding operation, the control unit controls such that the device discovering operation is stopped.

8. A method for discovering a device in a portable terminal, the method comprising:
performing a device discovering operation for a connection in a communication mode; and
when at least one condition for stopping the device discovering operation is satisfied during the device discovering operation, stopping the device discovering operation.

9. The method as claimed in claim 8, wherein said communication mode corresponds to Wi-Fi Peer-to-Peer or Wi-Fi Direct.

10. The method as claimed in claim 8, wherein the at least one condition for stopping the device discovering operation comprises a lapse of a predetermined device searching time period, a device selection for creating a group, and a termination of a related application.

11. The method as claimed in claim 8, wherein the stopping of the device discovering operation comprises:
performing a scanning operation in the device discovering operation; and
stopping the device discovering operation when at least one of the lapse of the predetermined device searching time period, the device selection for creating the group, and the termination of the related application is satisfied during the scanning operation.

12. The method as claimed in claim 11, further comprising:
performing a finding operation when the scanning operation in the device discovering operation is completed; and
stopping the device discovering operation when at least one of the lapse of the predetermined device searching time period, the device selection for creating the group, and the termination of the related application is satisfied during the finding operation.

13. The method as claimed in claim 12, wherein the stopping of the device discovering operation comprises:
performing a listening operation in the finding operation;
stopping the device discovering operation when at least one of the lapse of the predetermined device searching time period, the device selection for creating the group, and the termination of the related application is satisfied during the listening operation;
performing a searching operation when a listening operation time elapses;
stopping the device searching operation when at least one of the lapse of the predetermined device searching time period, the device selection for creating the group, and the termination of the related application is satisfied during the searching operation; and
performing the listening operation when the searching operation is completed.

14. A method of device discovery in a terminal supporting Wi-Fi Peer-to-Peer (P2P), the method comprising:
scanning each communication channel to identify whether another Wi-Fi P2P device is present;
setting a random listening time;
responding to any received request from another Wi-Fi P2P device for the set random listening time;
after the set random listening time elapses, scanning predetermined channels and informing the user of the existence of the another Wi-Fi P2P device; and
when a predetermined condition occurs during the scanning of each communication channel, the responding to the received request, and/or the scanning of the predetermined channels, terminating the method of device discovery.

15. The method of claim 14, wherein the predetermined condition comprises the lapse of a predetermined device discovery time.

16. The method of claim 14, wherein the predetermined condition comprises the selection of a device for creating a group.

17. The method of claim 14, wherein the predetermined condition comprises the termination of a Wi-Fi P2P-related application executed by the terminal.
